(19) United States
(12) Patent Application Publication
(10) Pub. No.: US 2015/0170087 A1
(43) Pub. Date: Jun. 18, 2015

(54) System And Method For Management Of A Drilling Process Having Interdependent Workflows

(71) Applicant: Schlumberger Technology Corporation, Sugar Land, TX (US)

(72) Inventors: Lucian Johnston, Sugar Land, TX (US); Jean-Michel, Houston, TX (US)

(21) Appl. No.: 14/569,185

(22) Filed: Dec. 12, 2014

Related U.S. Application Data
(60) Provisional application No. 61/916,182, filed on Dec. 14, 2013.

(51) Int. Cl. G06Q 10/06

(52) U.S. Cl. CPC G06Q 10/06316

(57) ABSTRACT

In one illustrative embodiment, a method includes identifying workflows in a multi-workflow process, identifying an interdependency between a first workflow and a second workflow of the process, determining the severity in which the first workflow and the second workflow is impacted in response to a change in a state or value of the interdependency, quantifying the severity information, and presenting the quantified severity information.

### CROSS-REFERENCE TO RELATED APPLICATIONS

This application claims benefit of U.S. Provisional Patent Application Ser. No. 61/916,182, filed Dec. 12, 2014, which is herein incorporated by reference.

### BACKGROUND

1. Technical Field

The present disclosure relates generally to process control and, more particularly, to control of a process that includes multiple workflows having interdependencies.

2. Background Information

This section is intended to introduce the reader to various aspects of art that may be related to various aspects of the subject matter described and/or claimed below. This discussion is believed to be helpful in providing the reader with background information to facilitate a better understanding of the various aspects of the present disclosure. Accordingly, it should be understood that these statements are to be read in this light, not as admissions of prior art.

Various industries rely on controlled processes for achieving or otherwise producing a desired output. Often, such processes are defined by a set of interrelated tasks that, when carried out, collectively provide the desired output. Each task may be associated with a corresponding workflow. A workflow, in its most general sense, may be defined as a set of steps or actions that are performed (e.g., automated, manually, etc.) to accomplish a particular task that is part of a given process.

In some processes, a certain parameter(s) pertaining to the process may be shared between two or more workflows. Thus, a change or adjustment in the state or value of such a parameter will potentially affect each workflow within the given process that relies upon it. In such a case, the workflows that rely on the shared parameter can be said to be interdependent, and the shared parameter can be referred to as an interdependent parameter or “interdependency.” When adjusting the state or value of an interdependency in one workflow, it is useful to understand the effects such an adjustment may have on other workflows within the process that rely the interdependency. For instance, if an interdependent parameter is adjusted to a desired value or state for one workflow, it may be important to know the impact on other workflows sharing the interdependent parameter. For example, will the other workflow(s) relying on the interdependent parameter continue to operate within tolerable parameters in response to the change?

As an example only, in the oil and gas industry, a drilling process can be used to drill a borehole into a formation. In practice, a typical drilling process can quite complex and may include a number of workflows that are implemented concurrently in the drilling process. In practice, multiple workflows could be implemented concurrently in a drilling process. For example, such workflows may include workflows for directional drilling, anti-collision, well placement, pore pressure, ECD management, wellbore stability, hole cleaning, fluid loss management, and rate of penetration (ROP) management, to name just a few examples.

Historically, workflows for drilling processes have been developed prior to a drilling operation via discussion amongst engineers and/or operators. For instance, at a wellsite, there is typically at least one designated individual that has responsibility for each workflow. When an operator in charge of one workflow wants to change a parameter (e.g., for improving performance of his workflow), the operator must determine the impact/risk on other workflows that depend on the changed parameter (e.g., determine if the other workflows will be capable of continued operation within desired operating limits if the change is affected). In such instances, the operator in charge of the first workflow would discuss the change with the operators of the other potentially affected workflows (those that share the interdependent parameter) to determine wither any impact/risk is acceptable. For example, each operator of an affected workflow may assess the impact and determine whether his/her workflow is still capable of operating within desired limits with the adjustment to the parameter and, if not, whether other parameters within the affected workflow can be adjusted to mitigate the impact and allow the affected workflow to continue operating within tolerable limits. Of course, if any of these other parameters are also interdependent, then that operator would have to discuss the change with the operators of the workflows that would be affected by changing those other parameters.

To further complicate matters, in modern drilling processes, the risk or impact on a workflow in response to changing the state or value of a parameter may further depend on the drilling rig activity (the activity the drilling rig is undergoing), sometimes referred to as “rig state.” In some drilling processes, between 6 to 10, or even as many as 13 different rig states may be associated with associated with the drilling process. Examples of rig states are discussed in more detail in commonly-assigned U.S. Pat. No. 7,128,167 entitled “System and Method for Rig State Detection,” which is hereby incorporated by reference. Thus, the risk/impact on a given workflow may depend at least partially upon the rig state when a workflow parameter is changed. For instance, under some rig states, the change may have a low risk or impact, and under other rig states, the change may have a high risk or impact that may, in some cases, be unacceptable.

Indeed, traditional techniques of managing interdependent parameters in a multi-workflow process have been difficult and, at times, unorganized. Further, as discussed above rig state dependency is an additional factor that may complicate the management of interdependent multi-workflow drilling processes. Accordingly, a system and method that better manages interdependent multi-workflow drilling processes is highly desirable.

### SUMMARY

A summary of certain embodiments disclosed herein is set forth below. It should be understood that these aspects are presented merely to provide the reader with a brief summary of certain embodiments and that these aspects are not intended to limit the scope of this disclosure. Indeed, this disclosure may encompass a variety of aspects that may not be set forth in this section.

In one illustrative embodiment, a method includes identifying workflows in a multi-workflow process, identifying an interdependency between a first workflow and a second workflow of the process, determining the severity in which the first workflow and the second workflow is impacted in response to a change in a state or value of the interdependency, quantifying the severity information, and presenting the quantified severity information.

The brief summary presented above is intended to familiarize the reader with certain aspects and contexts of embodiments of the present disclosure without limitation to the claimed subject matter.

### BRIEF DESCRIPTION OF DRAWINGS

The present disclosure is best understood from the following detailed description when read with the accompanying figures. It is emphasized that, in accordance with standard practice in the industry, various features are not necessarily drawn to scale. In fact, the dimensions of various features may be arbitrarily increased or recued for clarify of discussion.

FIG. 1 is a schematic diagram of a wellsite system that may be used for implementation;

FIG. 2 shows an example of interdependent workflows in a drilling process in accordance with aspects of the present disclosure;

FIG. 3 is an example of a risk matrix table in accordance with aspects of the present disclosure;

FIG. 4 is another example of a risk matrix table in accordance with aspects of the present disclosure;

FIG. 5 is an example of a graphical depiction of impact severity of interdependent workflows in response to changing the state/value of an interdependent parameter in accordance with aspects of the present disclosure;

FIG. 6 is an example embodiment of a method in accordance with aspects of the present disclosure; and

FIG. 7 shows an example computer system adapted to perform one or more of the methods described herein in accordance with aspects of the present disclosure.

### DETAILED DESCRIPTION

One or more specific embodiments of the present disclosure are described below. These embodiments are merely examples of the presently disclosed techniques. Additionally, in an effort to provide a concise description of these embodiments, all features of an actual implementation may not be described in the specification. It should be appreciated that in the development of any such implementation, as in any engineering or design project, numerous implementation-specific decisions are made to achieve the developers' specific goals, such as compliance with system-related and business-related constraints, which may vary from one implementation to another. Moreover, it should be appreciated that such development efforts might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The embodiments discussed below are intended to be examples that are illustrative in nature and should not be construed to mean that the specific embodiments described herein are necessarily preferential in nature. Additionally, it should be understood that references to “one embodiment” or “an embodiment” within the present disclosure are not to be interpreted as excluding the existence of additional embodiments that also incorporate the recited features.

It should also be noted that in the description provided herein, computer software is described as performing certain tasks. Furthermore, while the description provides for embodiments with particular arrangements of computer processors and peripheral devices, there is virtually no limit to alternative arrangements, for example, multiple processors, distributed computing environments, web-based computing, and so forth. All such alternatives are to be considered equivalent to those described and claimed herein.

In this disclosure, the term “storage medium” may represent one or more devices for storing data, including read-only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

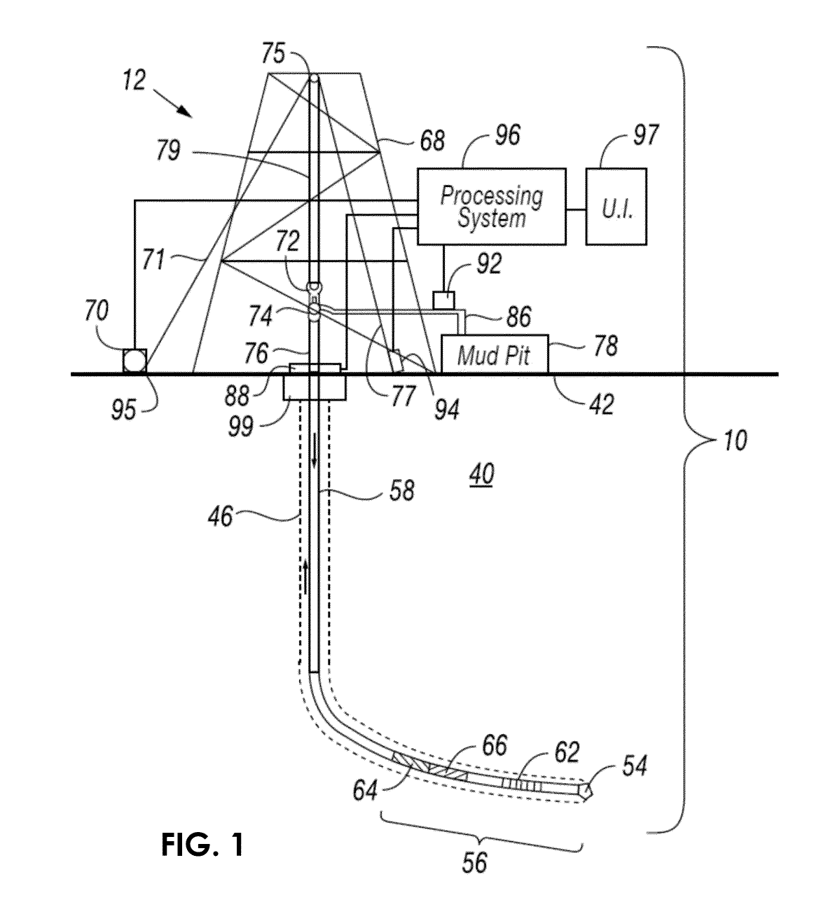

With the foregoing points in mind, FIG. 1 shows a drilling system 10, in accordance with one embodiment. The drilling system 10 may be configured to perform a drilling operation process based on multiple workflows. As discussed in more details below, some workflows may be interdependent in the sense that certain parameters are shared, whereby adjustment one on parameter will impact both all workflows dependent on the parameter. As depicted, a drill string 58 is shown within a borehole 46. The borehole 46 is located in the earth 40 having a surface 42. The borehole 46 is being cut by the action of a drill bit 54. The drill bit 54 is disposed at the far end of the bottomhole assembly 56 that is itself attached to and forms the lower portion of the drill string 58.

The bottomhole assembly 56 contains a number of devices including various subassemblies. According to an illustrative embodiment, measurement-while-drilling (MWD) subassemblies and/or logging-while-drilling (LWD) subassemblies may be included in subassemblies 62. Examples of typical MWD measurements include direction, inclination, survey data, downhole pressure (inside the drill pipe, and outside or annular pressure), resistivity, density, and porosity. The subassemblies 62 may also include a subassembly for measuring torque and weight on bit. Examples of LWD measurements may include formation evaluation measurements, and the LWD subassemblies may thus include one or more formation evaluation logging tools, such as nuclear magnetic resonance (NMR), resistivity, neutron, acoustic/sonic, density, dielectric, and/or nuclear logging tools.

The subassemblies 62 may generate signals related to the measurements made by the subassemblies 62. The signals from the subassemblies 62 may be processed in processor 66. After processing, the information from processor 66 may be communicated to communication assembly 64. The communication assembly 64 may comprise a pulser, a signal processor, an acoustic processor and/or the like. The communication assembly 64 converts the information from processor 66 into signals that may be communicated as pressure pulses in the drilling fluid, as signals for communication through an optic fiber, a wire and/or the like, or signals for wireless or acoustic communication and/or the like. The subassemblies in the bottomhole assembly 56 can also include a turbine or mud motor for providing power for rotating and steering drill bit 54. In different embodiments, other telemetry systems, such as wired pipe, fiber optic systems, acoustic systems, and wireless communication systems, may be used to transmit data to the surface system.

The drilling rig 12 includes a derrick 68 and hoisting system, a rotating system, and a mud circulation system. The hoisting system, which suspends the drill string 58, includes draw works 70, fast line 71, crown block 75, drilling line 79, traveling block and hook 72, swivel 74, and deadline 77. The rotating system includes kelly 76, rotary table 88, and engines (not shown). The rotating system imparts a rotational force on the drill string 58 as is well known in the art. Although a system with a kelly and rotary table is shown in FIG. 1, those of skill in the art will recognize that the present invention is also applicable to top drive drilling arrangements. Although the drilling system is shown in FIG. 1 as being on land, those of skill in the art will recognize that the present invention is equally applicable to marine environments.

The mud circulation system pumps drilling fluid down the central opening in the drill string. The drilling fluid is often called mud, and it is typically a mixture of water or diesel fuel, special clays, and other chemicals. The drilling mud is stored in mud pit 78. The drilling mud is drawn in to mud pumps (not shown), which pump the mud through stand pipe 86 and into the kelly 76 through swivel 74 which contains a rotating seal. The mud passes through drill string 58 and through drill bit 54. As the teeth of the drill bit grind and gouge the earth formation into cuttings, the mud is ejected out of openings or nozzles in the bit with great speed and pressure. These jets of mud lift the cuttings off the bottom of the hole and away from the bit 54, and up towards the surface in the annular space between drill string 58 and the wall of borehole 46. At the surface, the mud and cuttings leave the well through a side outlet in blowout preventer 99 and through mud return line (not shown). Blowout preventer 99 may include a pressure control device and a rotary seal. The mud return line feeds the mud into separator (not shown) which separates the mud from the cuttings. From the separator, the mud is returned to mud pit 78 for storage and re-use.

Various sensors, as are known in the art, may be placed on the drilling rig 10 to take measurements of the drilling equipment. In particular, hookload is measured by hookload sensor 94 mounted on deadline 77, block position and the related block velocity are measured by block sensor 95 which is part of the draw works 70. Surface torque is measured by a sensor on the rotary table 88. Standpipe pressure is measured by pressure sensor 92, located on standpipe 86. Additional sensors may be used to detect whether the drill bit 54 is on bottom. Signals from these measurements are communicated to a central surface processing system 96. Mud pulses traveling up the drillstring may be detected using pressure sensor 92. For instance, pressure sensor 92 may include a transducer that converts the mud pressure into electronic signals. In the illustrated embodiment, the pressure sensor 92 is connected to surface processing system 96 that converts the signal from the pressure signal into digital form, and stores and demodulates the digital signal into useable MWD data.

In accordance with aspects of the present disclosure, the surface processing system 96 is programmed to implement a process and system for mapping and managing interdependencies between drilling workflows, and may transmit information to a user interface 97, which may include a graphical user interface. A brief summary of such a process and system is first provided here, with additional details to be provided with reference to the additional figures below.

As discussed above, drilling processes often include multiple workflows. Many modern drilling processes may include workflows for directional drilling, pore pressure, well placement, anti-collision, equivalent circulating density (ECD) management, wellbore stability management, hole cleaning, fluid loss management, rate of penetration measurement, and so forth. This list of example workflows is not limited and, indeed, other drilling processes may include more or fewer workflows. As also discussed above, the workflows of a drilling process may include one or more interdependencies (e.g., parameters that are shared between two or more workflows). Thus a change in an interdependent parameter in one workflow has the potential to impact another workflow that contains that parameter. Examples of interdependent parameters may include weight-on-bit (WOB), drilling fluid (mud) flow rate, drill string revolutions per minute (RPM), mud weight, hydrostatic pressure, hook load, and, rheology. Again, it is understood that this list of example parameters is non-limiting and other drilling processes may include more or fewer parameters.

In accordance with embodiments of the present disclosure, an interdependent multi-workflow management system may be configured to identify the workflows that are part of an interdependent multi-workflow drilling process, identify and map interdependencies between the workflows, assess the impact and/or severity of the interdependent parameters on affected workflows in terms of a risk factor, and generating a risk matrix that allows operators to more quickly assess in the field the impact of changing the state/value of an interdependent parameter on the workflows relying on that parameter. Because the impact and severity of a change in an interdependent parameter may also be dependent on rig state, this is also taken into account, such that different corresponding risk matrices may be determined for each rig state encountered in a drilling operation. The disclosed interdependent multi-workflow management system may occur in real-time or during planning phases of a drilling operation. Accordingly, this allows drilling operators to improve drilling operations by optimizing drilling workflows and also allows drilling operators to quickly assess the impact of a change of an interdependent parameter in one workflow on other workflows that share the parameter.

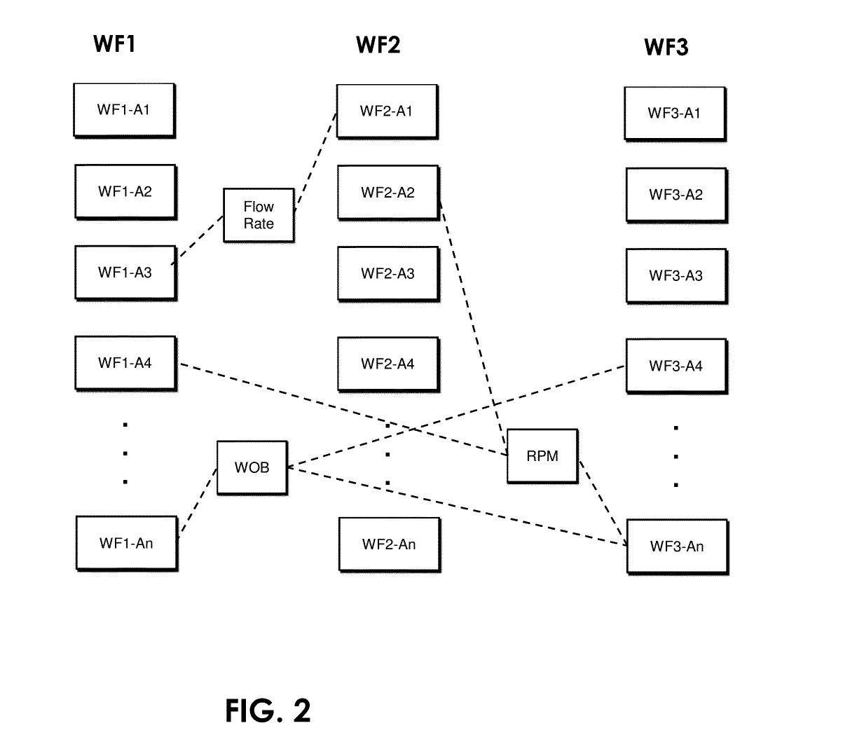

Referring to FIG. 2, a set of example workflows having interdependent parameters is illustrated as an interdependency map in accordance with aspects of the present disclosure. In its more general terms, a workflow can be thought of as a set of steps or actions that are performed (e.g., automated, manually, etc.) to accomplish a particular task that is part of a given process. In the illustrated examples, workflows WF1, WF2, and WF3 may represent workflows in a drilling operation. Each workflow may include a set of actions (e.g., may be sequential actions) that are carried out to achieve an objective. For instance, WF1 includes actions WF1-A1 to WF1-An (actions 1-n), WF2 includes actions WF2-A1 to WF1-An, and WF3 includes actions WF3-A1 to WF3-An. This is illustrative example three instances of interdependent parameters are shown. Mud flow rate is depicted as being an interdependency between WF1 and WF2 with respect to actions WF1-A3 and WF2-A1, respectively. That is to say, changing flow rate has the potential to affect both WF1 and WF2. Thus, if an operator wishes to change flow rate (e.g., increase or decrease) to improve the performance of WF1, it may be important to assess the severity of its impact on WF2 as well. Weight on bit (WOB) is shown as an interdependency between WF1 and WF3 with respect to actions WF1-An in WF1 and actions WF3-A4 and WF3-An in WF3. Thus, changing WOB may have an impact on both WF1 and WF3. Further, drill string RPM is shown as being an interdependency between WF1, WF2, and WF3 and, therefore, changing RPM may have an impact on WF1, WF2, and WF3. It will be understood that three workflows and three interdependent parameters are shown as a simplified example for clarity and that more workflows and parameters may be present in an actual drilling process.

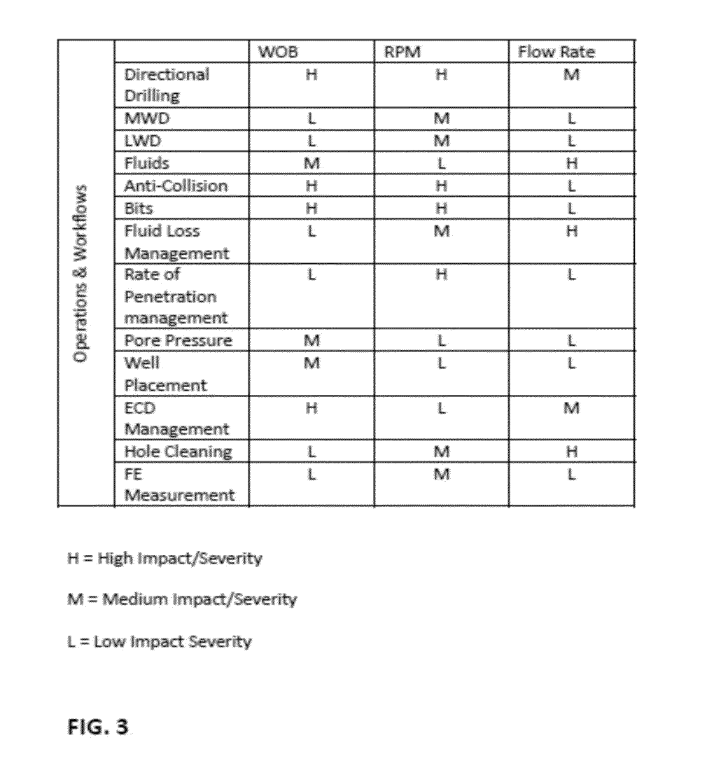

Once the interdependencies between the workflows are mapped, their impact on specific workflows may be quantified in terms of impact severity. In one embodiment, a risk matrix may be generated, an illustrative example of which is shown in FIG. 3. The table of FIG. 3 depicts a matrix that showing the severity of impact of changing interdependent parameters for a given workflow. For example, referring WOB, it can be seen that a change in WOB has a high impact on a directional drilling workflow, but a low impact on pore pressure and well placement workflows in this particular drilling process. Thus, this information allows a drilling operator to quickly identify that if a change in WOB for a particular workflow, such as pore pressure, is desired, the other interdependent workflows that have the potential to be most greatly impacted. Of course, it should be understood that while three levels of severity (H, M, L) are shown in the present example, other implementations and embodiments may use more or fewer levels of severity. For instance, in one embodiment, the impact severity may be rated on a scale of 1-10, with 10 being the most severe and 1 being the least severe.

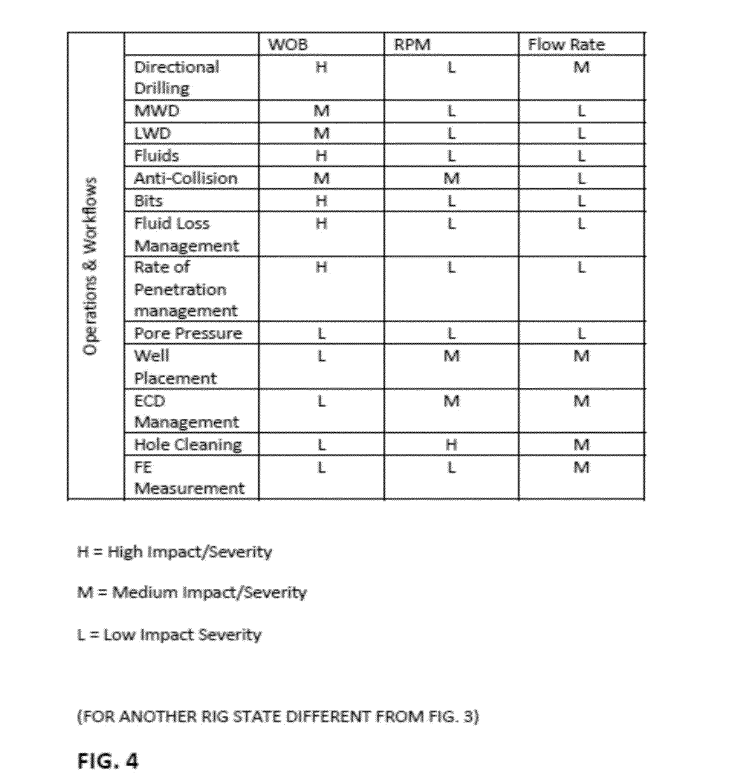

Embodiments of the interdependent multi-workflow management system described in the present disclosure may also be configured to generate multiple risk matrices, each corresponding to a particular rig state. This is because, depending on rig state, certain parameters may affect workflows. Referring to FIG. 4, a risk matrix similar to that shown in FIG. 3 is provided, but represents a different rig state. For example, in the rig state represented by FIG. 4, it can be seen that a change in RPM has a low severity on the directional drilling workflow, while RPM has a high severity on the directional drilling workflow in FIG. 3. Thus, when a change in an interdependent parameter is desired, the operator requesting the change may be able to refer to the appropriate risk matrix (corresponding to whatever the current rig state is) in order to obtain accurate information on how the change in the parameter would impact other interdependent work flows. In one embodiment, different risk matrices may be available for each rig state, and may be selected by the operator for viewing, such as via the user interface 97 (FIG. 1). In another embodiment, a single risk matrix table may be displayed, with severity values (e.g., H, M, L) being updated dynamically depending on the rig state. That is, the tables in FIGS. 3 and 4 need not be separate discreet tables, but may update dynamically during the drilling process based on the current rig state. In some embodiments, RACI charts containing this information may also be generated/outputted by the interdependent multi-workflow management system.

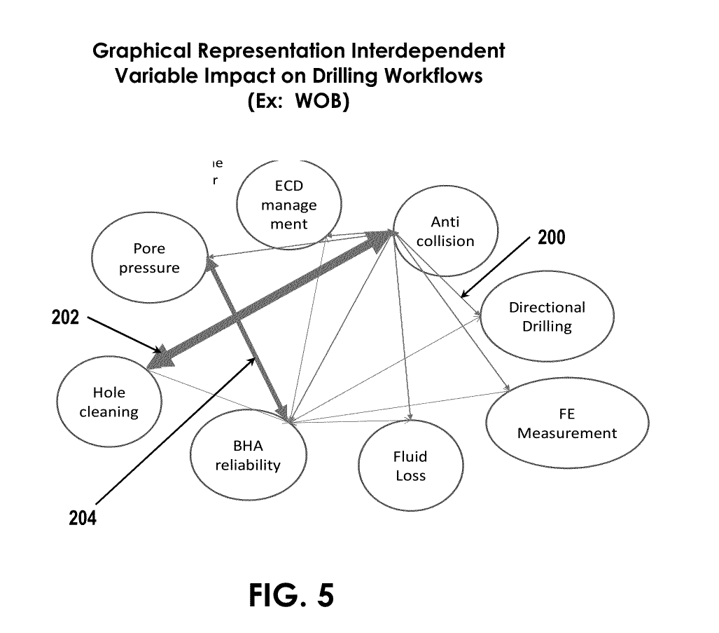

In further embodiments, a graphical representation of severity impact may be generated, as shown in FIG. 5. Here, for a given parameter such as WOB, interdependent workflows in the process are displayed. The impact severity in changing WOB in one workflow with respect to other interdependent workflows is represented by the line weight or thickness of the arrows shown in FIG. 5. Each arrow represents an impact of changing a given interdependent parameter (WOB in this example). For instance, it can be seen that changing WOB in the anti-collision workflow impacts all of the other workflows. For most workflows, the impact is low. For example, the impact on directional drilling workflow due to a change in WOB in the anti-collision workflow is designated by the thin arrow 200. However, it can be seen that changing WOB in the anti-collision workflow may have a high level of impact on the hole cleaning workflow, as designated by the thick arrow 202, and vice versa. Similarly, it can be seen that changing WOB in either the pore pressure or BHA reliability workflows can have a medium impact, as indicated by arrow 204.

For each interdependent parameter in the process, a graphical “web” diagram like that depicted in FIG. 5 may be displayable on a user interface 97. Further, different graphical diagrams may be provided for each parameter for each rig state. In another embodiment, a single graphical diagram may be provided for each parameter that updates dynamically depending on the rig state. That is, the graphical diagrams need not be separate for each rig state for a given parameter (e.g., one diagram for WOB impact for a first rig state and another diagram for WOB impact for a second rig state), but may update dynamically during the drilling process based on the current rig state. As can be appreciated, the graphical diagrams may be displayed instead of or in addition to the risk matrix tables discussed with reference to FIGS. 3 and 4.

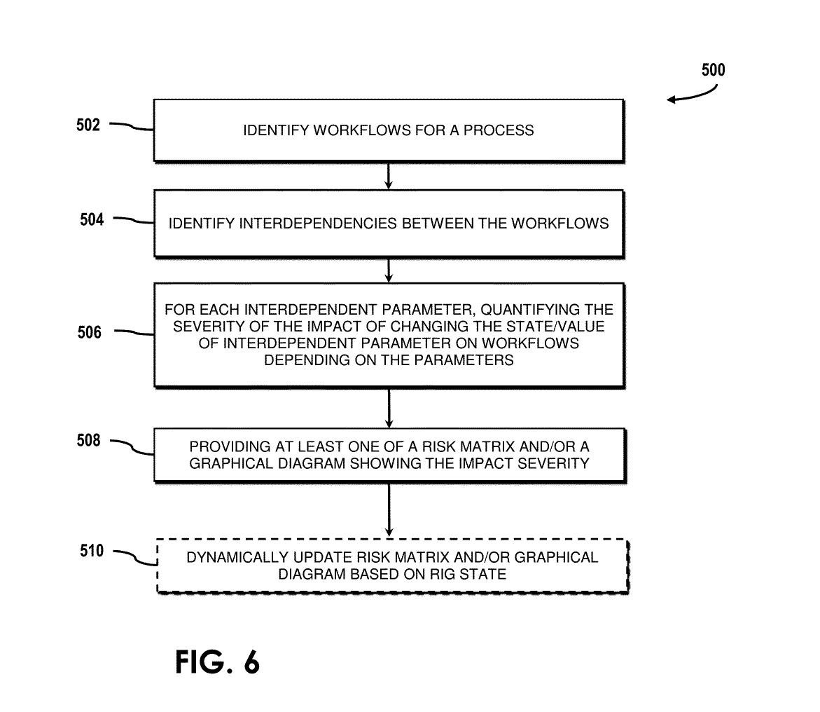

FIG. 6 is a flow chart showing a process 500 for interdependent multi-workflow management in accordance with aspects of the present disclosure. The process 500 includes identifying workflows for a process (502), such as a drilling process. Once the workflows are identified, interdependencies between the workflows are mapped (504). For each interdependent parameter, the severity of the impact (can be referred to as “risk”) in changing the state/value of that interdependent parameter on workflows depending on the parameter is quantified (506). For instance, this may be done by providing a risk matrix table with values representing severity of impact (H, M, L, etc.). This quantified data may then be provided visually, such as by a risk matrix table (e.g., FIGS. 3. and 4) and/or a graphical web diagram (e.g., FIG. 5) (508). In an embodiment where rig state is taken into account, the risk matrix and/or graphical web diagram may be updated dynamically as rig states change during the drilling process (510).

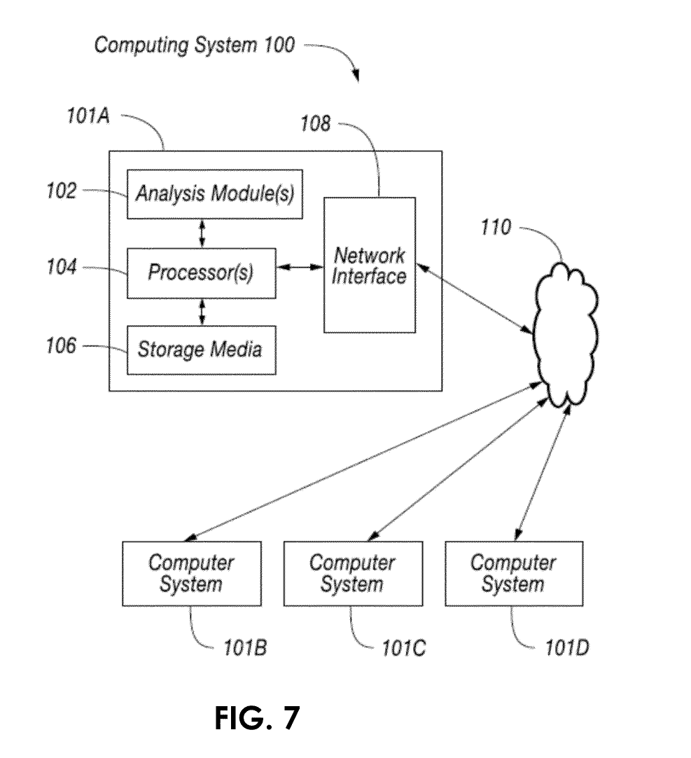

Referring to FIG. 7, a computing system 100 that may be part of the surface processing system 96 is depicted and represents an embodiment of a processor-based computing system that may implement the process and system for mapping and managing interdependencies between drilling workflows.

The computing system 100 can be an individual computer system 101A or an arrangement of distributed computer systems. The computer system 101A includes one or more analysis modules 102 that are configured to perform various tasks according to some embodiments, such as the tasks depicted in FIGS. 3-6. To perform these various tasks, an analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, in a well logging unit disposed proximate a wellbore drilling, while in communication with one or more computer systems such as 101C and/or 101D that are located in one or more data centers on shore, other ships, and/or located in varying countries on different continents).

A processor can include a microprocessor, microcontroller, processor module or subsystem, programmable integrated circuit, programmable logic devices (PLDs), field-gate programmable arrays (FPGAs), application-specific integrated circuits (ASICs), system-on-a-chip processors (SoCs), or any other suitable integrated circuit capable of executing encoded instructions stored, for example, on tangible computer-readable media (e.g., read-only memory, random access memory, a hard drive, optical disk, flash memory, etc.). As used herein, the term “computer” or “computer system” or the like should be understood to refer to any suitable computing device having a processor and which is adapted to perform one or more of the methods disclosed herein. For instance, a computer may include handheld computing devices or mobile device (e.g., smart phones, tablets, etc.).

The storage media 106 can be implemented as one or more non-transitory computer-readable or machine-readable storage media. Note that while in the embodiment of FIG. 7 the storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that computing system 100 may have more or fewer components than shown, may combine additional components not depicted in the embodiment of FIG. 2, and/or computing system 100 may have a different configuration or arrangement of the components depicted herein. The various components shown in FIG. 11 may be implemented in hardware, software, or a combination of both hardware and software, including one or more signal processing and/or application specific integrated circuits.

As will be understood, the various techniques described above and relating an interdependent multi-workflow management system and method are provided as example embodiments. Accordingly, it should be understood that the present disclosure should not be construed as being limited to only the examples provided above. Further, while discussed with reference to examples of drilling processes, it will be understood that the presently described methods and techniques are applicable to virtually any industry in which interdependent multi-workflows are used in a process.

While the specific embodiments described above have been shown by way of example, it will be appreciated that many modifications and other embodiments will come to the mind of one skilled in the art having the benefit of the teachings presented in the foregoing description and the associated drawings. Accordingly, it is understood that various modifications and embodiments are intended to be included within the scope of the appended claims.

What is claimed is:

1. A method comprising:
identifying a plurality of workflows in a multi-workflow process;
identifying an interdependency between a first workflow and a second workflow of the process;
determining the severity in which the first workflow and the second workflow are impacted in response to a change in a state or value of the interdependency;
quantifying the severity information; and
presenting the quantified severity information.

2. The method of claim 1, wherein presenting the quantified severity information comprises presenting the quantified severity information in a risk matrix.

3. The method of claim 2, where quantifying the severity information comprises classifying the impact as high, medium, or low and presenting these values in the risk matrix.

4. The method of claim 1, wherein presenting the quantified severity information comprises presenting the quantified severity information in a graphical web diagram, wherein workflows relying on the interdependency are connected by arrows

5. The method of claim 4, wherein quantifying the severity information comprises adjusting the thickness or line weight of the arrows based on the degree of severity.

6. The method of claim 1, wherein the multi-workflow process is a drilling process.
